(19) United States
(12) Patent Application Publication
(10) Pub. No.: US 2017/0006986 A1
(43) Pub. Date: Jan. 12, 2017

(54) COMPACT PERSONAL ILLUMINATED BILLBOARD

(71) Applicants: Perry John Sieber, Green Bay, WI (US); David Marcusen, Hortonville, WI (US); Alex Hunt, Eau Claire, WI (US)

(72) Inventors: Perry John Sieber, Green Bay, WI (US); David Marcusen, Hortonville, WI (US); Alex Hunt, Eau Claire, WI (US)

(21) Appl. No.: 14/796,932

(22) Filed: Jul. 10, 2015

(51) Int. Cl. A45C 11/18; G09F 13/22; F21S 9/02; G09F 23/00

(52) U.S. Cl. CPC A45C 11/18; G09F 23/00; G09F 13/22; F21S 9/02; G09F 2023/0025; G09F 2013/222; F21Y 2101/02

(57) ABSTRACT

A card holder and illuminated display device with a lower portion and an upper portion, where the lower includes a card holding space and a power source. The upper portion configured to cover the card holding space in the closed position and allow access to the card holding space in the open position. The upper portion also including a signaling panel, while the device includes a light source positioned so that in the open position the signaling panel of the upper portion may be edge illuminated. The panel may incorporate a design that is highlighted when the light source is turned on.

### CROSS-REFERENCE TO RELATED APPLICATION

The present application claims priority to earlier-filed U.S. Provisional Application Ser. No. 62/022,869, filed on Jul. 10, 2014, the disclosure of which is incorporated herein by reference in its entirety.

### BACKGROUND

Today, many workers have been unshackled from offices and fixed business locations. Many of today's workers are able to perform their jobs or even operate their businesses from mobile locations that can really be anywhere there is sufficient internet connectivity. Many times, these mobile workers set up in coffee shops or other public locations in the interest of having a stimulating work environment and access to food, drink and other people. Without a fixed office or cubicle, with an attached nameplate or other identifier, it can be difficult for these mobile workers to let other people around them know who they are, what their business is and whether they are open to making contact or having conversation about their work. Setting out business cards or slapping a sticker on the back of one's laptop are not really effective methods and are not adaptable to let others know when you might not wish to be disturbed and when you are open to a conversation.

Further, when a business person visits a marketing or sales environment, such as an industry show or convention, it may be desirable for that business person to effectively communicate who they are and who they represent in an eye-catching fashion that will invite conversation and contacts. Conventional devices for displaying identity and business information do not provide a desired level of visibility and information display.

Improvements to these conventional identification techniques for mobile workers and business persons are desirable.

### BRIEF DESCRIPTION OF THE DRAWINGS

The accompanying drawing figures, which are incorporated in and constitute a part of the description, illustrate several aspects of the present disclosure and together with the description, serve to explain the principles of the present disclosure. A brief description of the figures is as follows:

FIG. 1 is a front perspective view of an improved signaling device and business card holder according to the present disclosure, shown in an open position.

FIG. 2 is a side perspective view of a second embodiment of an improved signaling device and business card holder according to the present disclosure, shown in an open position.

FIG. 3 is a perspective view of a third embodiment of an improved signaling device and business card holder according to the present disclosure.

FIG. 4 is a perspective view of the signaling device and business card holder of FIG. 3 shown in a closed position.

FIG. 5 is a front view of the signaling device and business card holder of FIG. 3.

FIG. 6 is a first rear perspective view of the signaling device and business card holder of FIG. 3.

FIG. 7 is a side view of the signaling device and business card holder of FIG. 3.

FIG. 8 is an exploded view of the signaling device and business card holder of FIG. 3.

### DETAILED DESCRIPTION

Reference will now be made in detail to exemplary aspects of the present disclosure which are illustrated in the accompanying drawings. Wherever possible, the same reference numbers will be used throughout the drawings to refer to the same or like parts.

As noted above, more people than ever are working remotely; at coffee shops, co-working spaces, airports, hotels, conferences, or other places away from home or the office. Business people in these environments are always looking for an edge: new customers, new vendors, new partners, new angles, or just to network. Introducing yourself is the first step in a conversation. Particularly in these unstructured environments, if a person does not have a little context or prompting to guide conversation with a user, initiating a conversation can be difficult. Placing one's business card on a table provides very little context for a conversation; such cards are typically not readable from more than a few feet and it could simply be a random card loitering.

It is desirable to have a device capable of brazenly displaying a business person's name and/or occupation as one way to initiate or invite a conversation. An illuminated nameplate brazenly states, “This is who I am and what I do, and ‘I want your attention.’” When business people work outside the home or office, they need to bring business cards with them. They serve an important purpose as a takeaway from a conversation, a reminder. It would be convenient to have an eye-catching advertising device which can conveniently store and display a number of cards and likewise provide the convenience of easily transporting them within one's pocket.

An illuminated nameplate may contain relevant information like business name and person's name. Armed with that information, a person passing by can approach the user knowing there is a better chance of a valuable outcome to a conversation. Assuming that the conversation proves valuable, and that contact information should be exchanged, the device of the present disclosure may add the convenience of holding business cards or the like, along with providing the visible display. Instead of searching or reaching for a separate device holding contact info, the device of the present disclosure may hold the cards within. The same device that instigated the contact can conveniently hold the contact information that others can take away. The device of the present application may incorporate an eye-catching advertising device with convenient storage for a number of cards and likewise provide the convenience of being easily transported within one's pocket.

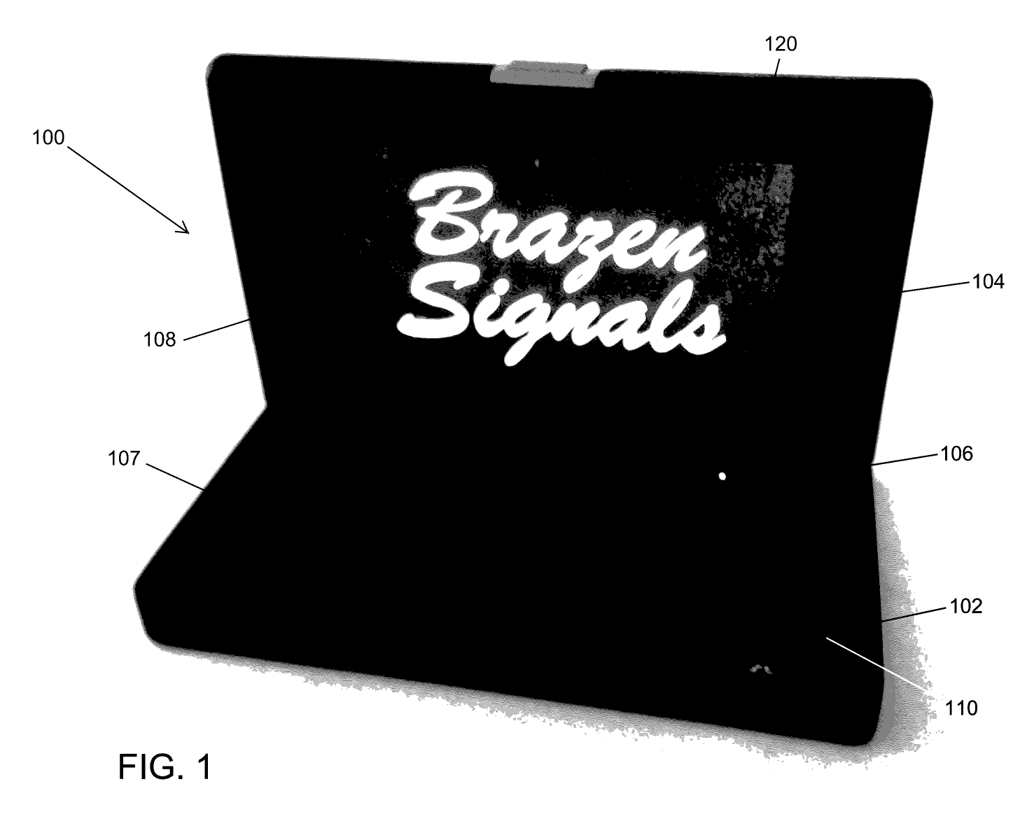

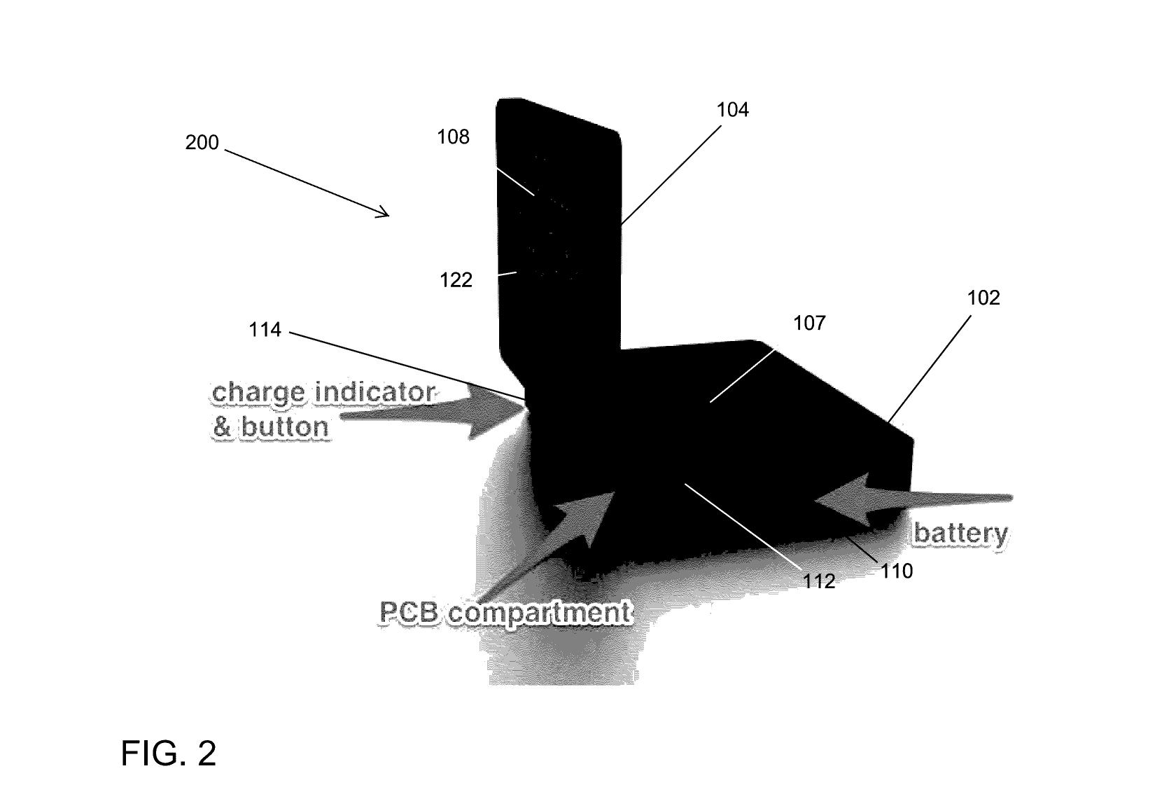

FIGS. 1 and 2 illustrate a device 100 and a device 200, both according to the present disclosure and both of which may be a combination of a lower portion business card holder 102 and an upper portion or lid 104 which may be configured with a hinged joint 106. Device 100 is shown in an open position with upper portion 104 pivoted up from lower portion 102 permitting access to a business card holding area 107. In this open position, a signaling element 108 of upper portion 104 may be visible to any person walking by a table where the device is placed or may be visible to others within the vicinity of the device. Signaling element 108 may be preferably a side lit panel with a design and/or name etched into the panel so that light directed into the panel will effectively highlight the design and/or name.

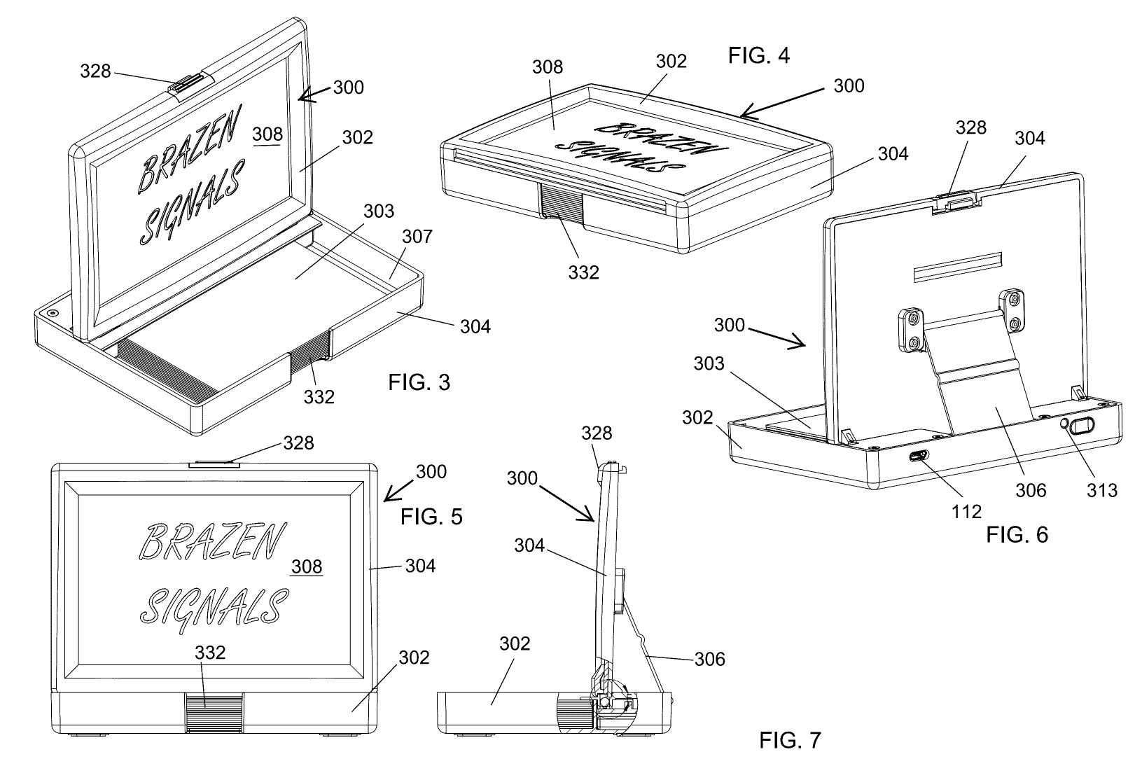

FIGS. 3 to 8 illustrate a third embodiment of a signaling device and business card holder 300 according to the present disclosure. Signaling device and card holder 300 may include a lower business card holding portion 302 and an upper lid portion 304 which may be hingedly joined by a hinge 306. Within lower portion 302 may be a business card holding area 307 within which may be placed one or a plurality of business cards 303. Lower portion 302 may further include a battery and electronics receiving area 309.

Upper portion 304 may include a signaling element 308 that is in optical contact with a light pipe 320 that is in optical contact with a plurality of LEDs 322 or similar efficient light sources mounted to an electronics assembly 324. Assembly 324 may be preferably in electrical contact with a power source such as a battery co-housed within electronics receiving area 309 of lower portion 302. A cover 326 may positioned so as to close off electronics receiving area 309 to secure and enclose the various elements with this area. When opened, as shown in FIG. 3, a lower edge 321 of signaling element 308 will be optical contact with light pipe 320 to permit light from LEDs 322 to illuminate signaling element 308 and any images, words or characters etched or embedded on the signaling element.

To secure device 300 in a closed position, a latch 328 may be included as part of upper portion 304. Latch 328 may be preferably configured to releasably engage a catch 330 that is incorporated into cover 326. In a closed position, latch 328 may engage catch 330. To open device 300, a user would depress the latch inward to disengage catch 330. A finger recess 332 may be provided in an opposite side of lower portion 302 to provide improved grip when the user is attempting to open device 300.

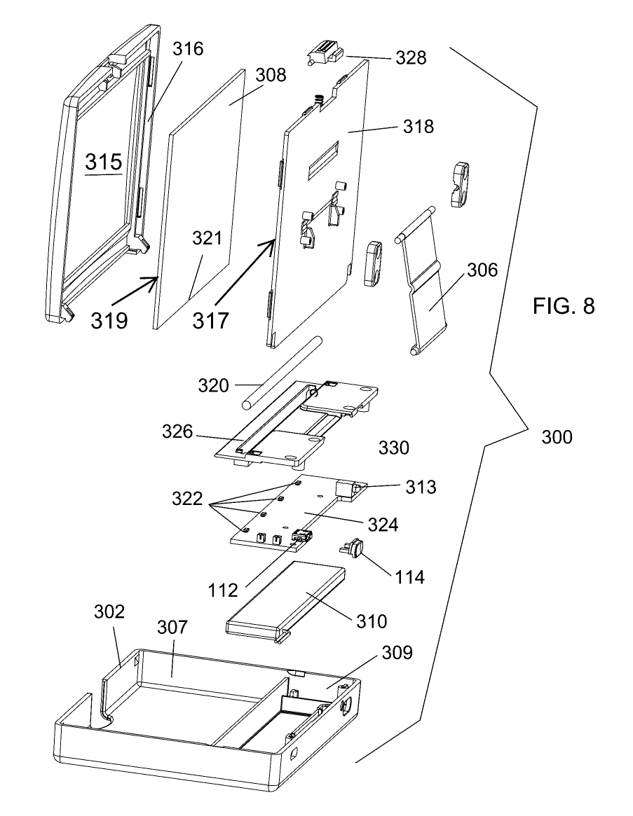

Referring now to FIG. 8, an exploded view of device 300 is provided to illustrate how the various elements within upper portion 304 and lower portion 302 may be arranged. This is an illustrative example only and is not intended to limit the scope of the present disclosure. Upper portion 304 may include a front bezel 316 and a rear cover 318 between which may be positioned signaling element 308. Light pipe 320 may be positioned with respect to electronics cover 326 so that light from the light sources 322 may be transmitted to lower edge 321 of signaling panel 308. Power source 310 may be positioned below or above electronic assembly 324 as appropriate for the particular configuration selected to accomplish the device as described herein.

While the signaling element has been described as an etched panel, it is also anticipated that signaling panel 308 (and 108) may be a non-etched panel with a translucent film 315 over a signaling or outer face 319 or signaling panel 308. With such a translucent film 315, the light source would be similarly positioned and arranged as shown and described herein, so that light would enter the panel through lower edge 321. However, instead of the etching of the panel highlighting the light to others looking at the outer or signaling face, a design included as part of the translucent film. Some portions of the translucent film may be more transparent than other portions and the light from the signaling panel would come through those portions more clearly than through other, less-transparent portions. Such a translucent film would also permit a greater variety of colors to be used as part of the illuminated words, images, designs or logos highlighted on the signaling panel. Such a film might be removably mounted to the signaling panel to permit easier changes to the words, images, designs or logos displayed by the device of the present disclosure.

To better enable the light from the signaling panel to illuminate the translucent film, a reflective material may be preferably applied to either a back or inner face of the signaling panel, opposite the outer or signaling face 319 and the translucent film. Alternatively, a side 317 of rear cover 318 adjacent the signaling panel may be coated with a reflective material to enhance light transmission through the signaling panel and translucent film.

Preferably, devices 100, 200 and 300 will not require connection to an external power source in normal operation. A removable connection, such as but not limited to a USB connection to a laptop or other portable device may be available to permit an on-board battery or other power source to be charged. As shown on FIGS. 2 and 6, a power source 110 and a power source 310 may be provided within lower portions 102 and 302, respectively, along with an external power connection port 112 and an external power button 114 that may or may not include an illumination feature to signal charge or operational status. The power button may be an illuminated button that can provide both a visible indication of charge or power status and there may be a separate indicator lamp, such as lamp 313 shown in FIGS. 6, 7 and 9, along with the power button.

From this point on, in the description, a reference to device 100 shall intended to include device 200 as well, as the two devices are similarly configured and functionally equivalent with minor differences for the location and certain elements.

While devices 100 and 200 are shown in an open position in FIGS. 1 and 2, it is preferable that upper portion 104 and lower portion 102 be hingedly connected to each other along join 106. Such a connection may permit the two portions to be folded back against each other in a closed position, covering business card area 107 and permitting easy storage and transportation of devices 100 and 200.

An alternative hinge arrangement is illustrated in FIGS. 3 to 8 but follows the same general concept of allowing device 300 to be closed for ease of transport and storage while also allowing device 300 to be opened to allow access to the business within and display of signaling element 308

It may be desirable to have LEDs or similar low power lamps within devices 100, 200 and 300 to selectively illuminate the panel of signaling element 108 and 308, and possibly highlight the etched name or design of the panel, or of the translucent film attached to the panel. Use of low power draw illumination elements will allow a longer battery life (reducing the need for devices 100, 200 and 300 to be tethered with a power cord) and permit smaller and more compact power sources to be located onboard devices 100, 200 and 300. It is not intended to limit the devices of the present application to any particular light source or power source, rather it is the intent of this disclosure that a most appropriate light source and accompanying power source be selected from the best available options. It is preferable that the device of the present disclosure, when in a closed position, will be sized in the range of common smartphones as an upper size limit and more conventional business card holders or cases as a lower size limit. Selection of the light and power source to provide effective illumination and battery life within these size parameters is preferable within the scope of the present disclosure.

To enable upper portions 104 and 304 to be constructed as trimly as possible, it may be desirable to have the light source to be housed within lower portions 102 and 302 along with any control circuits or printed circuit boards that may be necessary to operate the selected light source. With such a configuration, upper portions 104 and 304 would only need to be as thick as the illuminated panel and the structure needed to support the illuminated panel. When devices 100, 200 and 300 are moved to the open position, the illuminated panel would then be positioned adjacent the light source so that the light source will project light into the edge of the illuminated panel. Such a configuration will also permit devices 100, 200 and 300 to not require wires or other electrical connectors crossing the hinged connection of joint 106 or hinge 306.

It is also anticipated that joint 106 may not be hinged. Upper and lower portions 104 and 102 may be two separate pieces that engage one another in the open and closed positions. Instead of a hinged connection, upper portion 104 may simply be disengaged from lower portion 102 in the closed position and inserted into a slot or seat formed within lower portion 102 to place device 100 in the open position. Such a configuration might permit secure and durable electrical connections between a power source and/or control circuitry in the lower portion with an unobtrusive light source located in the upper portion without the need for wires crossing joint 106. Mating edge connectors might be built into the upper and lower portions that are only engaged when the upper portion is placed in the open position.

While the description above has been with respect to business cards, it is anticipated that other cards or collateral sales materials may be held within and dispensed by devices 100, 200 and 300. It is not intended to limit these devices to use with any particular card or collateral sales material, but examples of possible materials may include but are not limited to business cards, gift cards, flat promotional items, playing cards, compact discs, or other similarly sized and shaped items. It may be desirable to have devices 100, 200 and 300 sized so that lower portions 102 and 302 may have the capacity to receive an additional stack of business cards alongside the business cards for the user of the device, permitting both collection and distribution of information or other materials. Such a dual card version may be sized to hold two stacks of playing cards as well.

It is anticipated that any variety of lighting colors may be used within the device as desired by the user to customize the display. Devices 100, 200 and 300 may incorporate a removable or changeable light filter that will permit the user to change light colors as desired. The illuminated panel may be made of any of a variety of colors or configurations of etching to change the color or intensity of display while utilizing a standard light source strength and color. Alternatively, devices 100, 200 and 300 may include a utility to alter the intensity of the light emitted by the light source to alter the intensity of the illuminated panel display. As a further alternative, a translucent film may be applied to the outer face of the signaling panel with one or a plurality of colors that would be illuminated by the light applied along the lower edge of the signaling panel and visible through any transparent or semi-transparent portions of the film.

It is anticipated that the upper portion of the device according to the present disclosure may incorporate a variety of outer bezels that may be changed or selected by the user. Such bezels may allow a user to alter the shape of the lighted display visible to others. Examples of different shapes might include but are not limited to having a house shaped display for a realtor, or a coffee cup shaped display for a user placing the device on their table at a coffee shop. Such selectable bezels may also include different light filter that will permit the user to alter the visual appearance of the lighted display without having to remove or replace the etched panels within the upper portion.

As shown in the FIGS, a pair of different panels may be incorporated into upper portion 104 so that the words/image displayed on a front side 120 and a rear side 122 of signaling element 108 of upper portion 104 may be separately customized and simultaneously displayed. Otherwise, a panel configured to be read from in front of device 100 would be backwards when viewed from behind the device. Alternatively, a single panel may be used that is opaque on rear side 122 so that only a front, correctly oriented image or words is displayed on front side 120.

While devices 100, 200 and 300 have been described herein as an advertising device, inviting contact with others in the area of the user, it is anticipated that the device may also be used to signal that the user does NOT desire contact. Devices 100, 200 and 300 may be configured to permit easy removal and replacement of illuminated panels so that a user may insert a panel with the words “DO NOT DISTURB” when the user wishes to simply get some work done. The display may still have the company name or logo illuminated and the device may still allow others to grab a business card without interrupting the user. Alternatively, devices 100, 200 and 300 may have two panels inserted into upper portion 104 or 304, one inviting contact and one indicating the user does not want contact, allowing the user to selectively display their current status by turning the device to outwardly display the appropriate panel.

It is anticipated that devices 100, 200 and 300 will be constructed with an outer case that is plastic for ease of manufacturing but it is not intended to limit the device to such an outer casing. Different materials may be selected to have the desired appearance, surface treatment, durability, etc., and it is not intended to limit the present description to any particular external structure.

While the invention has been described with reference to preferred embodiments, it is to be understood that the invention is not intended to be limited to the specific embodiments set forth above. Thus, it is recognized that those skilled in the art will appreciate that certain substitutions, alterations, modifications, and omissions may be made without departing from the spirit or intent of the invention. Accordingly, the foregoing description is meant to be exemplary only, the invention is to be taken as including all reasonable equivalents to the subject matter of the invention, and should not limit the scope of the invention set forth in the following claims.

What is claimed is:

1. A card holder and illuminated display device comprising:
a lower card holding portion and an upper signaling display portion, the upper and lower portions selectively moveable between open and closed positions;
the lower card holding portion including a card holding space and a power source;
the upper signaling display portion configured to cover the card holding space in the closed position and allow access to the card holding space in the open position;
the upper signaling display portion further including a signaling panel, the device further including a light source electrically connected to the power source, the light source being positioned so that in the open position the signaling panel of the upper signaling display portion may be illuminated by the light source entering the signal panel through a lower edge, the signaling panel further incorporating at least one of a word, a design, an image and a logo that is highlighted when the light source is turned on.

2. The card holder and illuminated display device of claim 1, further comprising the light source mounted within the lower card holding portion.

3. The card holder and illuminated display device of claim 2, further comprising the light source optically connected to the signaling panel via a light pipe when the device is in the open position.

4. The card holder and illuminated display device of claim 1, further comprising a power source mounted within the lower card holding portion.

5. The card holder and illuminated display device of claim 4, further comprising the power source is rechargeable and the lower portion includes a port for receiving a power cord.

6. The card holder and illuminated display device of claim 1, further comprising the light source is at least one LED mounted to an electronics assembly mounted within the lower portion of the device.

7. The card holder and illuminated display device of claim 1, further comprising the signaling panel including etching which may include the at least one of a word, a design, an image or a logo, so that the light from the light source will illuminate the etching and make it visible on the signaling panel.

8. The card holder and illuminated display device of claim 1, further comprising the signaling panel including a translucent cover on an outer face of the signal panel, with the translucent cover including the at least one of a word, a design, an image or a logo, as a combination at least one of a transparent element and a semi-transparent element, so that the light from the light source will illuminate any transparent or semi-transparent elements and make them visible on the signaling panel.
